(19) United States
(12) Patent Application Publication
(10) Pub. No.: US 2015/0002663 A1
(43) Pub. Date: Jan. 1, 2015

(54) Systems and Methods for Generating Accurate Sensor Corrections Based on Video Input

(71) Applicant: GOOGLE INC., Mountain View, CA (US)

(72) Inventors: Weibin Pan, Shanghai (CN); Liang Hu, Hubel (CN)

(73) Assignee: GOOGLE INC., Mountain View, CA (US)

(21) Appl. No.: 14/250,193

(22) Filed: Apr. 10, 2014

Related U.S. Application Data
(63) Continuation of application No. PCT/CN2013/078296, filed on Jun. 28, 2013.

(51) Int. Cl. H04N 7/18; G06T 15/04; G06T 11/00; H04N 5/232

(52) U.S. Cl. CPC H04N 7/183; H04N 5/23229; G06T 15/04; G06T 11/001
USPC 348/142

(57) ABSTRACT

A portable device includes a sensor, a video capture module, a processor, and a computer-readable memory that stores instructions. When executed on the processor, the instructions operate to cause the sensor to generate raw sensor data indicative of a physical quantity, cause the video capture module to capture video imagery of a reference object concurrently with the sensor generating raw sensor data when the portable device is moving relative to the reference object, and cause the processor to calculate correction parameters for the sensor based on the captured video imagery of the reference object and the raw sensor data.

### CROSS-REFERENCE TO RELATED APPLICATION

This application is a continuation of, and claims priority to, International Application No. PCT/CN2013/078296, filed Jun. 28, 2013, and titled “Systems and Methods for Generating Accurate Sensor Corrections Based on Video Input,” the entire disclosure of which is hereby expressly incorporated by reference herein.

### FIELD OF TECHNOLOGY

The present disclosure relates generally to devices equipped with motion sensing modules and, more particularly, to developing accurate corrections for the sensors employed in such modules.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In recent years, sensors, such as accelerometers, gyroscopes, and magnetometers, have decreased in cost as a result of advancements in the field of micro-electro-mechanical systems (MEMS). These inexpensive sensors are widely used in mobile devices, such as smartphones, tablet computers, etc., to control or trigger software applications by sensing relative motion (up and down, left and right, roll, pitch, yaw, etc.). However, the low-cost sensors used in mobile devices have a low degree of accuracy compared to sensors used in commercial or industrial applications, such as unmanned aircraft or manufacturing robots.

Sensors with three-dimensional (3D) vector output, such as accelerometers, magnetometers, and gyroscopes, for example, are prone to sensor bias errors, which can be seen as a difference between an ideal output of zero and an actual non-zero output, and cross-axis inference errors, caused by non-orthogonality in chip layout and analog circuit interference. In general, errors in the sensors used by motion sensing modules may be categorized into “drift” errors and “cross-axis” errors. Drift errors are defined as a constant shift between the real data, or expected output, and the raw sensor data. The sensor bias error of an accelerometer is an example of a drift error. Cross-axis errors are defined as errors that are not separable into components associated with individual coordinates (i.e. the errors are coupled to multiple coordinates). The cross-axis interference of the magnetometer is an example of a cross-axis error.

In an effort to increase the accuracy of motion sensing results, some motion sensing modules with multiple sensors use sensor fusion to optimize results. Generally speaking, sensor fusion refers to combining data from multiple sensors so that the resulting information has a higher degree of reliability than information resulting from any one individual sensor. The data produced by multiple sensors may be redundant and may have varying degrees of reliability, and thus the data from multiple sensors often has optimal combinations. A simple sensor fusion algorithm may use a weighted average of data from multiple sensors to account for varying degrees of reliability while more sophisticated sensor fusion algorithms may optimize the combination of sensor data over time (e.g. using a Kalman filter or linear quadratic estimation).

In theory, sensor fusion techniques provide accurate motion sensing results even when the individual sensors employed have a low degree of reliability. However, in practice, sensor fusion has certain disadvantages for some combinations of sensors. For example, the complexity of the sensor fusion algorithms increases dramatically as the number of available sensors (i.e. the “feature set”) increases. Thus, high computational cost makes sensor fusion intractable for motion sensing modules using a large number of sensors and/or sensors with complicated sources of error (e.g. cross-axis errors). On the other hand, a small number of sensors may severely limit any increase in measurement accuracy with sensor fusion. The number of sensors, therefore, greatly influences the utility of sensor fusion techniques. In fact, sensor fusion techniques may even be completely impractical in some scenarios where the available sensors are of different and incompatible types. Although some portable devices now implement sensor fusion, the implemented techniques at best compensate for basic drift errors without compensating for cross-axis errors.

### SUMMARY

According to one implementation, a portable device includes a sensor, a video capture module, a processor, and a computer-readable memory that stores instructions. When executed on the processor, the instructions operate to cause the sensor to generate raw sensor data indicative of a physical quantity, cause the video capture module to capture video imagery of a reference object concurrently with the sensor generating raw sensor data when the portable device is moving relative to the reference object, and cause the processor to calculate correction parameters for the sensor based on the captured video imagery of the reference object and the raw sensor data.

According to another implementation, a method for efficiently developing sensor error corrections in a portable device having a sensor and a camera is implemented on one or more processors. The method includes causing the sensor to generate raw sensor data indicative of a physical quantity while the portable device is moving relative to a reference object. Further, the method includes causing the camera to capture a plurality of images of the reference object concurrently with the sensor generating the raw sensor data. Still further, the method includes determining multiple position and orientation fixes of the portable device based on the plurality of images and geometric properties of the reference object and calculating correction parameters for the sensor using position and orientation fixes and the raw sensor data.

According to yet another implementation, a tangible computer-readable medium stores instructions. When executed on or more processors, the instructions cause the one or more processors to receive raw sensor data generated by a sensor operating in a portable device and receive video imagery of a reference object captured by a video capture module operating in the portable device. The raw sensor data and the video imagery are captured concurrently while the portable device is moving relative to the reference object. The instructions further cause the one or more processors to calculate correction parameters for the sensor using the captured video imagery of the reference object and the raw sensor data.

### BRIEF DESCRIPTION OF THE DRAWINGS

FIG. 1 illustrates an example scenario in which a portable device develops sensor corrections based on captured video imagery of a reference object.

FIG. 2 illustrates an example system in which a portable device develops sensor corrections via a sensor correction routine.

FIG. 3 is a flow diagram of an example method for generating sensor corrections based on captured video imagery.

FIG. 4 is a flow diagram of an example method for generating periodic sensor corrections.

FIG. 5 is a flow diagram of an example method for identifying objects in captured video imagery and matching the identified objects with reference objects.

### DETAILED DESCRIPTION

The techniques of the present disclosure can be utilized to develop sensor corrections for portable devices, such as smartphones, tablet computers, special-purpose devices that process continuous video input, etc. based on captured video imagery of reference objects. A reference object can be a standard real world object with a corresponding representation of the object as digital data, such as a three dimensional (3D) reconstruction of the object, stored in a database. According to the techniques of the disclosure, a portable device is equipped with one or more sensors, captures video imagery of a reference object and calculates, based on that video imagery and representations of reference objects in the reference object database, accurate position and/or orientation fixes as a function of time (a position fix identifies the geographic location of the portable device and an orientation fix identifies the orientation of the portable device with respect to the center of mass of the portable device). The portable device also collects raw sensor data (accelerometer data, gyroscope data, etc.) concurrent with the captured video imagery. A sensor correction routine develops correction parameters for one or more of the sensors contained in the portable device based on the position and/or orientation fixes and the raw sensor data. These corrections can be applied continuously and updated periodically to improve sensing, effectively calibrating the sensors.

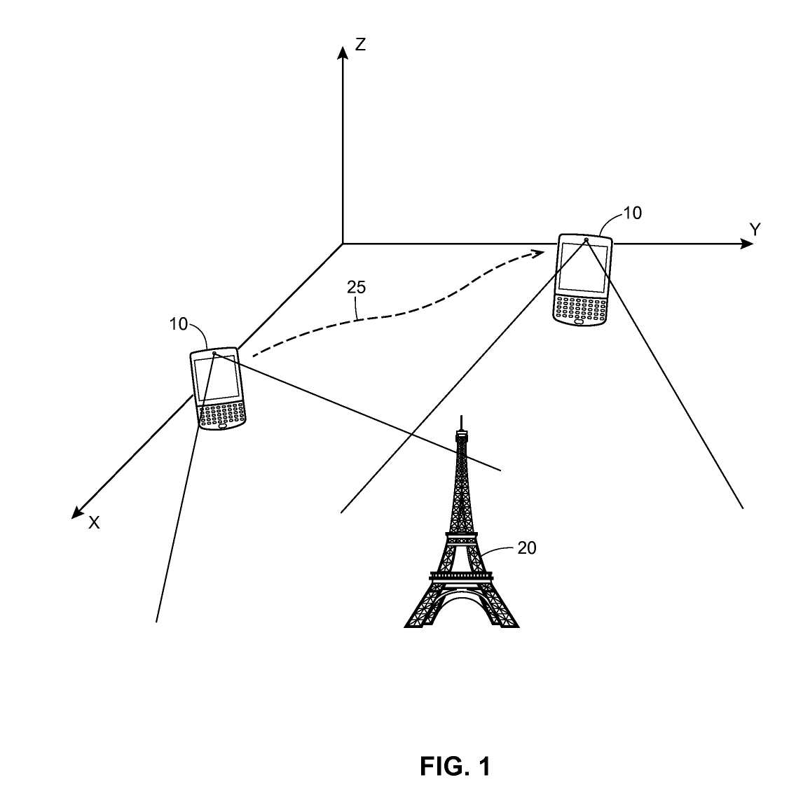

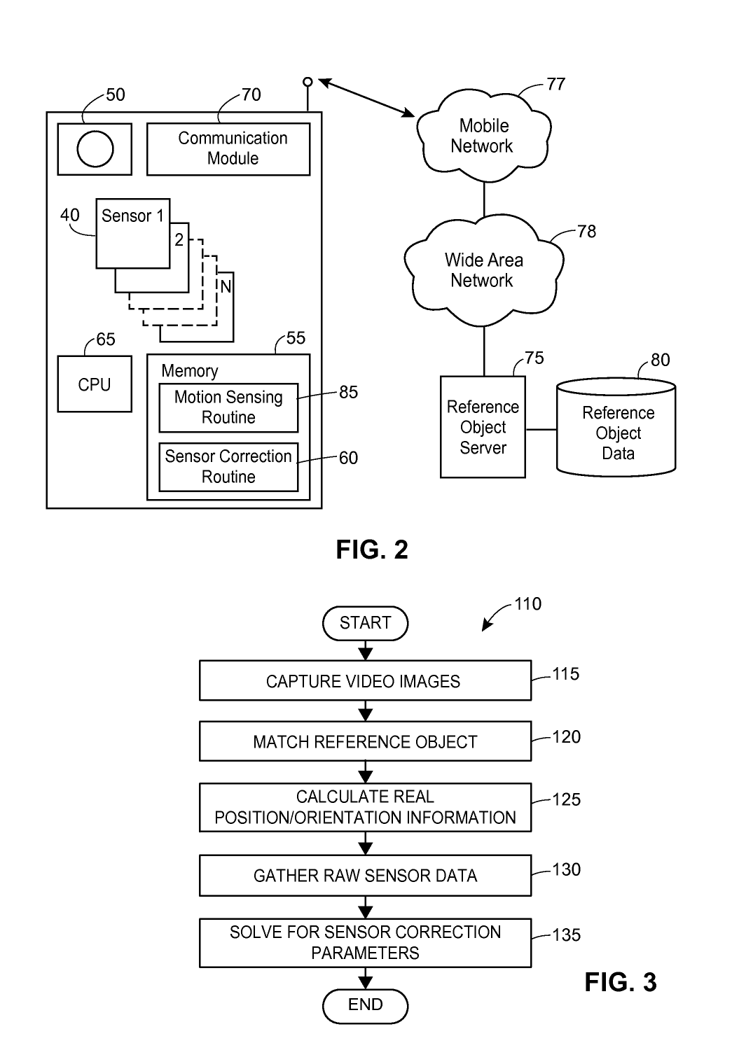

FIG. 1 illustrates an example scenario in which a portable device 10 develops sensor corrections based on captured video imagery of a reference object 20. The portable device 10 contains, among other things, a plurality of sensors, such as motion sensors. These sensors may be inexpensive MEMS sensors, such as accelerometers, magnetometers, and gyroscopes, for example. In addition, one or more wireless interfaces communicatively couple the portable device 10 to a mobile and/or wide area network. An example implementation of the portable device 10 will be discussed in more detail with reference to FIG. 2.

The example reference object 20 can be a landmark building, such as the Eiffel Tower or Empire State Building, for example. In some cases, a digital 3D model corresponding to the reference object 20 is stored in a reference object database. The digital 3D model may represent the shape of the reference object with points on a 3D mesh, a combination a simple shapes (e.g. polygons, cylinders), etc, and the appearance of the reference object with colors, one or more still images, etc. Further, the reference object database stores specific properties of the reference object such as geometric proportions, measurements, geographic location, etc. The reference object database may be a database of 3D models, such as the Google 3D Warehouse®, accessible through the internet, for example.

As the portable device 10 moves through 3D space, as indicated by a path 25, the portable device 10 captures video imagery. The video imagery is composed of unique consecutive images, or frames, that include the reference object 20. As the portable device 10 moves along the path 25, the position and/or orientation of the portable device 10 changes with respect to reference object 20, and, thus, video imagery frames captured at different points along the path 25 show the reference object 20 from different points of view.

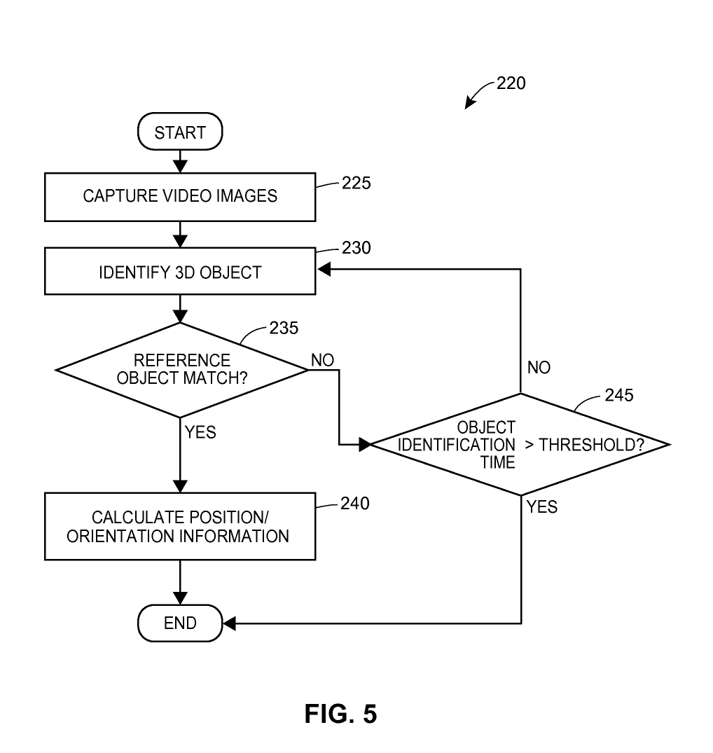

In some implementations, the portable device 10 reconstructs the 3D geometry and appearance of reference object 20 from one or more captured two dimensional (2D) video imagery frames (e.g. with Structure From Motion, or SFM, techniques). Further, the portable device 10 attempts to match the reconstructed 3D geometry and appearance of the reference object 20 (referred to as the “3D object reconstruction” in the following) to a 3D model in the reference object database. Example matching procedures are discussed in detail in reference to FIG. 2 and further in reference to FIG. 5.

Upon matching the reconstructed 3D geometry and/or appearance to an appropriate digital 3D model, the portable device 10 downloads properties of the reference object 20 from the reference object database. For example, properties can include measurements such as height, width, and depth of the reference object 20 in appropriate units (e.g. meters). The portable device 10 develops accurate position and/or orientation fixes based on the 3D object reconstruction and properties of the reference object 20. The height of the reference object 20 in a video imagery frame and the measured height of the reference object may indicate, for example, the distance of the portable device 10 from the reference object 20. The position and/or orientation fixes correspond to various times at which the one or more video imagery frames were captured.

The portable device 10 uses the accurate position and/or orientation fixes to generate sensor corrections. Some sensor corrections may be calculated directly from the position and/or orientation fixes, while the development of other sensor corrections may involve further transformations of the position and/or orientation fixes. For example, the development of accelerometer corrections may require an intermediate calculation, where the intermediate calculation involves calculating an average acceleration based on multiple position fixes, for example.

After correction development, a sensing routine, such as a motion sensing routine, applies sensor corrections to improve raw sensor data. For example, a motion sensing routine may collect raw sensor data, calculate observables (acceleration, orientation, etc.), and apply the sensor corrections to the observables. The sensor corrections may be updated over time by capturing and analyzing further video imagery of the previously analyzed reference object 20 or a new reference object. Thus, the sensing of the portable device 10 is improved via sensor corrections, where the sensor correction is based on captured video imagery of reference objects.

FIG. 2 illustrates an example system in which the portable device 10 develops sensor corrections for one or more sensors 40 based on video imagery of reference objects, such as the reference object 20. The portable device 10 contains a video image capture module 50 to capture video imagery of reference objects. For example, the portable device 10 may trigger the video image capture model 50 to capture video imagery for a short time (e.g. 5-10 seconds) and subsequently execute a sensor correction routine 60 to develop sensor corrections based on the captured video imagery, as discussed below.

The video image capture module 50 may include a CCD video camera, Complementary Metal-Oxide-Semiconductor (CMOS) image sensor, or any other appropriate 2D video image capture device, for example. In some embodiments, the portable device 10 includes 3D image capture devices such as secondary cameras, Light Detection and Ranging (LIDAR) sensors, lasers, Radio Detection and Ranging (RADAR) sensors, etc. Additionally, the image capture module 50 may include analog, optical, or digital image processing components such as image filters, polarization plates, etc.

A sensor correction routine 60, stored in computer-readable memory 55 and executed by the CPU 65, generates one or more 3D object reconstructions of a reference object (representing shape and appearance of the reference object) using one or more of the video imagery frames. For example, the sensor correction routine 60 may select a predefined number of frames in the video imagery and use 3D reconstruction techniques to develop one or more 3D object reconstructions of a reference object based on the selected frames.

The 3D object reconstructions may be developed in any appropriate 3D model format known in the art, and the 3D object reconstruction may represent the reference object as a solid and/or as a shell/boundary. For example, the 3D object reconstruction may be in the STereoLithography (STL), OBJ, 3DS, Polygon (PLY), Google Earth®, or SketchUp® file formats.

A communication module 70 sends one or more of the 3D object reconstructions to a reference object server 75 via a mobile network 77 and a wide area network 78. Subsequently, the reference object server 75 attempts to match the one or more 3D object reconstructions and/or other representations of the reference object with reference 3D models stored in a reference object database 80 on computer-readable storage media that can include both volatile and nonvolatile memory components. A variety of metrics may be used to match a 3D object reconstruction with a reference 3D model in the reference object database 80. For example, the reference object server 75 may decompose the 3D object reconstruction and the reference 3D models into a set of parts, or distinguishing features, where a match is defined as a 3D object reconstruction and a 3D model possessing a similar part set. Alternatively, the reference object server 75 may compare distributions of distances between pairs of sampled points on a 3D dimensional mesh, referred to as a shape distribution, where a match is defined as a 3D object reconstruction and a 3D model with a similar shape distribution, for example.

In some embodiments, the communication module 70 sends all or part of the captured video imagery to the reference object server 75. The reference object server 75 may match the video imagery itself with a reference 3D model in the reference object database 80. For example, the reference object server 75 may analyze multiple frames of the video imagery that show the reference object from varying points of view. Based on these points of view, the reference object server 75 may assign a score to at least some of the 3D models in the reference object database, where the score indicates the probability that the 3D model and video imagery are both representing the same object. A high score may define a match between a 3D model and the video imagery, for example. According to one implementation, the portable device 10 provides both the captured video imagery and raw sensor data (along with sensor information to identify the type of sensor) to a network server such as the reference object server 75.

Upon matching the video imagery with a reference 3D model, the reference object server 75 sends an indication of the properties of the matched reference object to the portable device 10. The sensor correction routine 60 of the portable device 10 uses the reference object properties, such as precise proportions and measurements of the reference object, and one or more 3D object reconstructions of the reference object to calculate accurate position and/or orientation fixes. The position and/or orientation fixes may be calculated according to any appropriate technique, such as known techniques in the area of 3D reconstruction and Augmented Reality (AR).

The sensor correction routine 60 develops sensors corrections according to the accurate position and/or orientation fixes. In some implementations, the develop of corrections involves simple direct operations, such as a direct difference between an accurate position fix and a raw data position fix output by one or more sensors, for example. In other cases, the development of corrections involves multiple chained operations such as coordinate transformations, matrix inversions, numerical derivatives, etc. For example, the development of a correction for a gyroscope sensor may involve a transformation of position/orientation fix coordinates from Cartesian coordinates to body-centered coordinates, a numerical derivative of a time-dependent rotation matrix (associated with multiple orientation fixes), a solution of linearly independent equations to derive accurate Euler angles, and a matrix inversion to calculate appropriate gyroscope correction parameters (e.g. a correction parameter for each of the three Euler angles). The development of specific sensor corrections will be discussed in more detail in reference to FIG. 3.

A motion sensing routine 85 stored in the memory 55 and executed by the CPU 65 applies the sensor corrections developed by the sensor correction routine 60 for improved sensing. For example, the motion sensing routine 85 may apply sensor correction parameters to the raw sensor data output from one or more of the sensors 40. The motion sensing routine may further process this corrected sensor data to develop and output desired observables (acceleration in certain units, orientation at a certain time, navigation predictions, etc.). The development of desired observables may involve the corrected sensor data corresponding to only one of the sensors 40, or the development may involve corrected sensor data corresponding to multiple of the sensors 40.

In some embodiments, the portable device 10 uploads 3D object reconstructions and calculated properties of objects to the reference object database 80, for use as reference objects by other devices. For example, the portable device 10 may improve sensing based on video imagery of an initial reference object, as discussed above, and the portable device 10 may use the improved sensing to gather properties, such as proportions, geographic location, etc., of a new real world object, where the new real world object is not represented by a 3D model in the reference object database 80. In addition, the portable device 10 may generate a 3D object reconstruction of the new real world object based on captured video imagery. The gathered properties of the new real world object and the 3D object reconstruction may then be uploaded to the reference object database 80, thus increasing the number of available reference objects in the reference object database 80.

Moreover, an example portable device, such as the portable device 10, may store 3D object reconstructions of frequently encountered reference objects in the local memory 55, where the memory 55 may be in the form of volatile and/or nonvolatile memory such as read only memory (ROM) and random access memory (RAM). These locally-stored 3D object reconstructions may be 3D models downloaded from a reference object database, such as the reference object database 80, or the locally stored 3D object reconstructions may be 3D object reconstructions of new real world objects generated based on captured video imagery. The portable device 10 may first attempt to match 3D object reconstructions with reference objects in the local memory 55 and then, if no appropriate match was found, attempt to match 3D object reconstructions with reference 3D models in a remote database. In this way, the portable device 10 may increase the efficiency of periodic sensor correction development by matching currently generated 3D object reconstructions with 3D object reconstructions of reference objects in the local memory 55, as opposed to necessarily exchanging reference object information with a remote server.

The reference objects, of which video imagery is captured in the techniques discussed above, may be landmark buildings, but a reference object is not limited to such landmarks, or even to building in general. A reference object may be any kind of object with corresponding reference information, where the reference information is used along with video imagery to develop sensor corrections. For example, a checkerboard, Quick Response (QR) code, Bar code, or other 2D object with known dimensions may be used as a reference object to develop sensors corrections for orientation sensors, proximity sensors, or other types of sensors.

Next, FIG. 3 illustrates an example method 110 for generating portable device sensor corrections based on captured video imagery. The method 110 may be implemented in the sensor correction routine 60 illustrated in FIG. 2, for example.

At block 115, video imagery is captured for a short time, T, by an image capture module of a portable device, such as the image capture module 50 of portable device 10. The time, T, may be a pre-defined amount of time required for sensor correction development, or the time, T, may be determined dynamically based on environmental conditions or the recent history of sensor behavior, for example. The video imagery is made up of one or more video imagery frames that include a reference object, where the video imagery frames are captured at a frame rate, 1/dt (i.e. the capture of each frame is separated in time by dt). A frame that includes the reference object may include all or just part of the reference object within the borders of the video imagery frame. The video imagery may include 2D video imagery captured by 2D video image capture devices and/or 3D video imagery captured by 3D video capture devices.

At block 120, a reference object in the video imagery is matched with a representation of the reference object in a local or remote reference object database. The representation of the object in the reference object database may include 3D models, proportion and measurement data, geographic position data, etc. In some embodiments, the matching of the video imagery with a reference object includes matching 3D models and/or 3D object reconstructions. In other embodiments, the video imagery is matched with appropriate 2D techniques, such as analyzing multiple 2D images corresponding to various view points, for example.

Next (block 125), an accurate position and/or orientation fix is calculated based on properties of the matched reference object and further processing of the video imagery. For example, 3D object reconstructions may be analyzed with knowledge of the reference object proportions to infer a position and/or orientation fix. Position and/or orientation fixes may be calculated for times corresponding to the capture of each video imagery frame (0, dt, 2dt, . . . , T), or a subset of these times. For example, a pre-defined number, M, of position and/or orientation fixes may be calculated, where the M position and/or orientation fixes correspond to a times at which M frames were captured (M<T/dt). These times corresponding to the subset of frames may be equally or non-uniformly spaced in time.

A 3D position fix may be represented by three Cartesian coordinates (x, y, z), and an orientation fix may be represented by three Euler angles (φ, θ, ψ) with respect to the center of mass of the portable device. The coordinates (x, y, z) may be defined with respect to an origin, x=y=z=0, at the location of the reference object, for example, and the Euler angles (φ, θ, ψ) may be defined with respect to an origin, φ=θ=ψ=0, at a horizontal orientation pointing towards the reference object, for example.

At block 130, raw sensor data is gathered for one or more sensors in the portable device. These sensors may output raw position data (x_{raw}, y_{raw}, z_{raw}) and raw orientation data (φ_{raw}, θ_{raw}, ψ_{raw}), or another three-component output such as the acceleration (a_{x,raw}, a_{y,raw}, a_{z,raw}) or geomagnetic vector (m_{x,raw}, m_{y,raw}, m_{z,raw}), for example. The sensors may also output other information with any numbers of components in any format. An example list of common sensors, that may be implemented in portable device, is included below. The list is not intended to be exhaustive, and it is understood that the techniques of the present disclosure may be applied to other types of sensors.

| Type: | Raw sensor data indicates: |
|---|---|
| Accelerometer | acceleration. |
| Barometer | pressure. |
| Gyroscope | object orientation. |
| Hygrometer | humidity. |
| Infrared Proximity Sensor | distance to nearby objects. |
| Infrared/Laser Radar Sensor | speed. |
| Magnetometer | strength and/or direction of magnetic fields. |
| Photometer | light intensity. |
| Positioning Sensor | geographic location. |
| Thermometer | temperature. |
| Ultrasonic Sensor | distance to nearby objects. |

At block 135, sensor correction parameters are developed. These correction parameters may be derived from the raw sensor data and position and/or orientation fixes that were generated at block 125. To illustrate the development of sensors corrections, the following description refers to raw sensor data as x_{raw}=(x_{raw}, y_{raw}, z_{raw}) and a real three-component property (e.g. actual position of the portable device) as x=(x, y, z). It is understood that x_{raw} and x could refer to any three-component properties such as orientation vectors, geomagnetic vectors, or other three-component properties. Furthermore, x_{raw} and x could refer to any derivable three-component property (i.e. derivable from position and/or orientation fixes) such as accelerations, velocities, angular velocities, etc.

The general structure of a raw data output may be represented by x_{raw}=a+Cx, where the vector a represents drift errors, the matrix C represents scaled ratios of (x, y, z) along the diagonal and cross-axis errors off diagonal, and the vector x represents the real three-component property (e.g. actual position, acceleration, etc.). In an expanded matrix representation, the raw data output is:

$$( \begin{matrix}{x}_{raw} \\ {y}_{raw} \\ {z}_{raw}\end{matrix} ) = ( \begin{matrix}{a}_{x} \\ {a}_{y} \\ {a}_{z}\end{matrix} ) + ( \begin{matrix}{c}_{xx} & {c}_{yx} & {c}_{zx} \\ {c}_{xy} & {c}_{yy} & {c}_{zy} \\ {c}_{xz} & {c}_{yz} & {c}_{zz}\end{matrix} ) ( \begin{matrix}x \\ y \\ z\end{matrix} ) \qquad ( Eq . 1 )$$

The equation, x_{raw}=a+Cx, expresses the raw data output in terms of the real/actual three-component property, but the equation may be inverted to express the real three-component property in terms of the raw data, x=C⁻¹(x_{raw}−a). Thus, knowledge of C⁻¹ and a would allow one to properly compensate for drift and cross-axis errors. The twelve unknown components in C⁻¹ and a can, therefore, be one representation of the sensor correction parameters discussed above.

Using the captured video imagery, the three-component property, x, can be accurately estimated for multiple positions/orientations of the portable device. For example, multiple position fixes, x(0), x(dt), x(2dt), . . . , x(T), may be calculated from multiple video imagery frames captured at times 0, dt, 2dt, . . . , T. Further, multiple derivable three-component properties may be calculated from the multiple position fixes. For example, multiple acceleration vectors, a(0), a(dt), a(2dt), . . . , a(T), may be calculated by taking numerical derivatives (e.g. with finite difference methods) of the multiple position fixes with a time step dt. Thus, using the captured video imagery and the gathered raw sensor data, at least twelve values of x_{raw}, are combined with at least twelve concurrent estimates of x (based on captured video imagery) to estimate the twelve sensor correction parameters in C⁻¹ and a. Further, if more than twelve (x_{raw}, x) pairs are available to the sensor correction routine, the estimates for C⁻¹ and a may be refined or optimized with respect to the supplementary data. For example, the estimates for C⁻¹ and a may be refined with a least squares or RANdom SAmple Consensus (RANSAC) method.

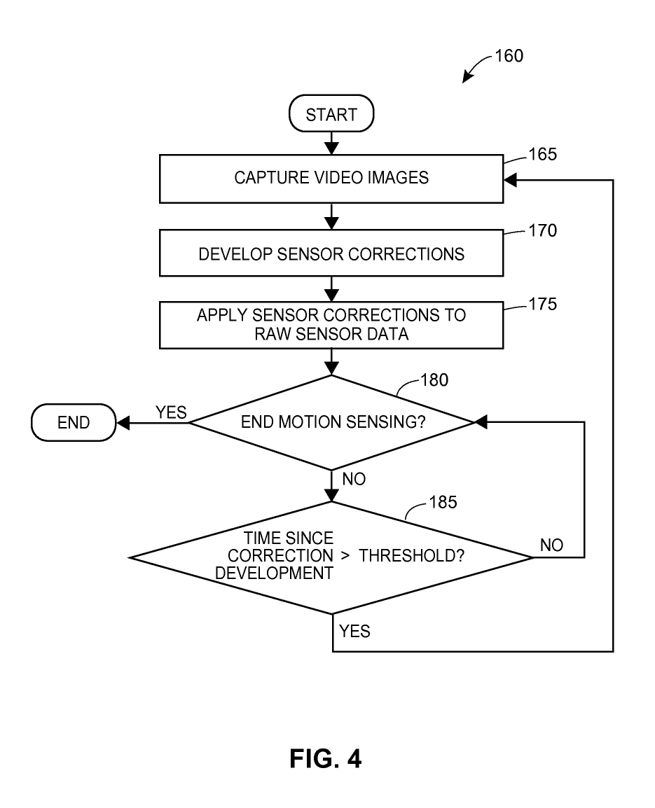

FIG. 4 illustrates an example method 160 for developing and periodically updating sensor corrections for improved motion sensing in a portable device. The method 160 may be implemented in the portable device 10 illustrated in FIG. 2, for example.

At block 165, video imagery is captured, where the video imagery includes a reference object. Based on this video imagery, a sensor correction routine develops sensor corrections at block 170. These sensors corrections are then applied to improve motion sensing at block 175. The improved motion sensing may be utilized in a navigation, orientation, range-finding, or other motion-based application, for example.

Next (block 180), the method 160 determines if the portable device requires further use of motion sensing or if motion sensing should end. A navigation application may be terminated to trigger an end of improved motion sensing, for example. In such a case, the method 160 ends, and the method 160 may be restarted when another application in the portable device requires the use of improved motion sensing. If, however, there an application on the portable device requires further use of motion sensing, the flow continues to block 185.

At block 185, the method 160 determines if the time since the last development of sensor corrections is greater than a threshold value. For example, a portable device may continuously improve sensing by periodically updating sensors corrections (e.g. update sensor corrections every minute, every ten minutes, every day, etc.), and, in this case, the threshold value would be equal to the period of required/preferred sensor correction updates. If the time since correction development is less than the threshold, the flow reverts to block 175, and the current sensor correction are used for improving further motion sensing. If, however, the time since correction development is greater than the threshold, the flow reverts to block 165 where new sensor corrections are developed based on newly captured video images.

In some embodiments, the time between sensor correction development (i.e. the threshold) is dynamically determined. For example, in certain conditions and/or geographic locations sensors are exposed to more or less error. In such cases, the threshold may be determined based on a position fix (such as a Geographic Position System, or GPS, position fix). Alternatively, the threshold may be dynamically determined based on statistical behavior of one or more sensors inferred from past usage of the one or more sensors.

FIG. 5 illustrates a method 220 for identifying 3D objects in video imagery and matching the 3D objects with reference objects in a reference object database. The method 220 may be implemented in the portable device 10 illustrated in FIG. 2, for example.

At block 225, an image capture module captures video imagery, where the video imagery may include one or more reference objects. The video imagery may be in any video imagery format, such as Moving Picture Expert Group (MPEG) 4, Audio Video Interleave (AVI), Flash Video (FLV), etc. Further, the video imagery may have any appropriate frame rate (24p, 25p, 30p, etc.) and pixel resolution (1024×768, 1920×1080, etc.).

At block 230, an object is identified in the video imagery via 3D reconstruction or any other appropriate technique. For example, an image capture device, such as a CCD camera, may capture multiple images with different points of view to infer the 3D structure of an object, or multiple image capture devices may capture stereo image pairs and use overlapped images to infer 3D structure. In some embodiments, the 3D structure of a single object or a plurality of object can be inferred from the video imagery.

At block 235, an attempt is made to match the 3D structure of the identified object with representations, such as 3D models, of reference objects in a reference object database. The reference object database may be a local database (i.e. stored in the local memory of the portable device) or a remote reference object database accessible by the portable device via a mobile and/or wide area network.

If the 3D structure of the identified object matches the structure of a reference object, the flow continues to block 240 where the portable device calculates accurate position and/or orientation fixes based on the video imagery of the object and information about the reference object. If, however, the 3D structure of the identified object does not match the structure of a reference object, the flow continues to block 245.

In some embodiments, geographic locations (e.g. surveyed positions, GPS position fixes) of the reference objects are stored in the reference object database. The portable device may used this geographic location information to order the reference objects such that geographically close reference objects are analyzed as potential matches before objects in far away geographic locations. For example, the portable device may generate an approximate position fix via a GPS or other positioning sensor, and rank the reference objects according to distance from the approximate position fix. In some embodiments, all reference objects in the database are considered as potential matches, and in other embodiments, only a pre-defined number of proximate reference object are considered as potential matches.

At block 245, it is determined whether the time that has been expended thus far in identifying and matching objects is greater than a threshold. If the time expended thus far is greater than the threshold, then the method 220 ends. Otherwise, the flow reverts to block 230 where a new or different object may be identified and potentially matched with a reference object.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for developing correction parameters for sensors using video input through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A portable device comprising:
a sensor;
a video capture module;
a processor; and
a computer-readable memory that stores instructions thereon, wherein the instructions, when executed by the processor, operate to:
cause the sensor to generate raw sensor data indicative of a physical quantity,
cause the video capture module to capture video imagery of a reference object concurrently with the sensor generating raw sensor data when the portable device is moving relative to the reference object, and
cause the processor to calculate correction parameters for the sensor based on the captured video imagery of the reference object and the raw sensor data.

2. The portable device of claim 1, wherein the instructions, when executed by the processor, further operate to identify the reference object as a standard real-world object having known geometric properties.

3. The portable device of claim 2, wherein the standard real-world object is a two-dimensional (2D) image on a 2D surface.

4. The portable device of claim 1, wherein the instructions, when executed by the processor, further operate to match the captured video imagery to a digital 3D model of the reference object, wherein:
the digital 3D model is stored in a database to which the portable device is coupled via a communication network, and
the digital 3D model specifies geometric properties of the reference object.

5. The portable device of claim 4, wherein to match the captured video imagery to the digital 3D model of the reference object, the instructions operate to transmit at least part of the captured video imagery to a reference object server coupled to the database, via the communication network.

6. The portable device of claim 4, wherein the instructions, when executed by the processor, further operate to generate an approximate position fix of the portable device for matching with a geolocation data of the digital 3D model.

7. The portable device of claim 1, wherein the sensor is one of:
(i) an accelerometer,
(ii) a gyroscope, or
(iii) a magnetometer.

8. The portable device of claim 1, wherein the instructions, when executed by the processor, further cause the processor to apply the correction parameters to subsequent raw sensor data output of the sensor.

9. The portable device of claim 1, wherein to calculate the correction parameters, the instructions operate to:
obtain geometric properties of the reference object,
apply a 3D reconstruction technique to the captured video imagery using the geometric properties of the reference object, and
calculate a plurality of position and orientation fixes of the portable device at respective times based on the captured video imagery.

10. The portable device of claim 9, wherein to calculate the correction parameters, the instructions operate to determine vector a and matrix C in x_{raw}=a+Cx, wherein:
vector x_{raw} represents raw sensor data,
the vector a represents to drift errors,
the matrix C represents cross-axis errors, and
x represents corrected raw sensor data;
wherein the instructions operate to determine the vector a and the matrix C using the plurality of position and orientation fixes of the portable device.

11. The portable device of claim 1, wherein the instructions, when executed by the processor, further operate to update the correction parameters periodically at a regular interval.

12. The portable device of claim 1, wherein the video capture module is configured to capture video imagery continuously while the portable device is operational.

13. A method implemented on one or more processors for efficiently developing sensor error corrections in a portable device having a sensor and a camera, the method comprising:
while the portable device is moving relative to a reference object, causing the sensor to generate raw sensor data indicative of a physical quantity;
causing the camera to capture a plurality of images of the reference object concurrently with the sensor generating the raw sensor data;
determining a plurality of position and orientation fixes of the portable device based on the plurality of images and geometric properties of the reference object; and
calculating correction parameters for the sensor using the plurality of position and orientation fixes and the raw sensor data.

14. The method of claim 13, the method further comprising transmitting the plurality of images to a reference object server via a communication network, wherein the reference object server matches the plurality of images to the reference object.

15. The method of claim 14, the method further comprising transmitting the raw sensor data and sensor information to the reference object server.

16. The method of claim 13, further comprising identifying the reference object as a standard real-world object having known geometric properties.

17. The method of claim 13, further comprising matching the plurality of images to a digital 3D model of the reference object, wherein the digital 3D model is stored in a database.

18. The method of claim 13, wherein matching the plurality of images to a digital 3D model of the reference object includes:
generating a set of one or more approximate positioning fixes of the portable device,
transmitting the set of one or more approximate positioning fixes to a reference object server via a communication network, and
receiving a geolocated digital 3D model of the reference object from the reference object server, wherein the geolocated digital 3D model is indicative of geometric properties of the reference object.

19. A tangible computer-readable medium storing thereon instructions that, when executed on or more processors, cause the one or more processors to:
receive raw sensor data generated by a sensor operating in a portable device;
receive video imagery of a reference object captured by a video capture module operating in the portable device, wherein the raw sensor data and the video imagery are captured concurrently while the portable device is moving relative to the reference object;
calculate correction parameters for the sensor using the captured video imagery of the reference object and the raw sensor data.

20. The computer-readable medium of claim 19, wherein to calculate the correction parameters, the instructions cause the one or more processors to:
determine geometric properties of the reference object,
determine position and orientation fixes of the portable device based on the geometric properties of the reference object and the video imagery,
determine correct sensor data corresponding to the raw sensor data based on the determined position and orientation fixes, and
calculate the correction parameters based on a difference between the correct sensor data and the raw sensor data.

21. The computer-readable medium of claim 20, wherein:
the sensor is an accelerometer, and
to calculate the correction parameters, the instructions cause the one or more processors to calculate average acceleration based on the plurality of position fixes.

22. The computer-readable medium of claim 20, wherein:
the sensor is a gyroscope, and
to calculate the correction parameters, the instructions cause the one or more processors to calculate a numerical derivative of a time-dependent rotation matrix associated with the plurality of orientation fixes.

23. The computer-readable medium of claim 20, wherein to determine the position and orientation fixes of the portable device, the instructions cause the one or more processors to apply 3D reconstruction.

24. The computer-readable medium of claim 19, wherein the movement of the portable device relative to the reference object includes a change in at least one of position and orientation relative to the reference object.
